(19) United States
(12) Patent Application Publication
(10) Pub. No.: US 2016/0208942 A1
(43) Pub. Date: Jul. 21, 2016

(54) HYDRAULIC PRESSURE REDUCER

(71) Applicant: Kenneth Ochenkowski, Northford, CT (US)

(72) Inventor: Kenneth Ochenkowski, Northford, CT (US)

(21) Appl. No.: 15/000,125

(22) Filed: Jan. 19, 2016

Related U.S. Application Data
(60) Provisional application No. 62/104,921, filed on Jan. 19, 2015.

(51) Int. Cl. F16K 17/04; F15B 15/20; F15B 15/14; G05D 16/06

(52) U.S. Cl. CPC F16K 17/04; G05D 16/0636; F15B 15/20; F15B 15/14

(57) ABSTRACT

A hydraulic system comprises a hydraulic fluid circuit including a hydraulic pressure reducer. The hydraulic fluid circuit comprises a supply line and a return line. A quick connect coupler is fluidly coupled to each of the supply line and the return line. A hydraulic control valve set is coupled to the supply line and the return line downstream of the quick connect couplers. A hydraulic piston cylinder assembly is coupled to the supply line and the return line downstream of said hydraulic control valve set. The hydraulic pressure reducer is fluidly coupled to at least one of the supply line and the return line between the quick connect coupler and the hydraulic control valve set.

### BACKGROUND

The present disclosure is directed to a device for controlling hydraulic pressure that has accumulated in a static hydraulic system. Specifically, the disclosure describes a system and device that prevents hydraulic fluid systems from over pressurizing and subsequently leaking hydraulic fluid to the environment.

The present invention generally relates to an apparatus for relieving hydraulic pressure in a hydraulic hose connected with hydraulically powered equipment in which the hose supplies hydraulic pressure to the equipment from a source of hydraulic pressure or returns hydraulic pressure from the equipment to a hydraulic fluid reservoir. The hydraulic hose is separable and connected to a hydraulic source by a quick coupler including a male and female component each of which includes a valve that is open as long as the quick coupler components are connected but will immediately close when the quick coupler components are disconnected thereby trapping hydraulic pressure in the hose. Any entrapped hydraulic pressure within the hose exerts pressure on the valve in the quick coupler component on the hose which makes it quite difficult to reconnect the male and female components of a quick coupler when reconnecting the hose to a hydraulic pressure source.

Referring to FIG. 1, hydraulically powered equipment 10 is used for various purposes such as on tractor trailer trucks 12 (shown), various agricultural equipment, industrial equipment, fork lifts, and the like. The equipment usually includes a hydraulic ram in the form of a piston and cylinder assembly 14, a hydraulic motor or the like connected to a source of hydraulic pressure 16 by flexible hoses 18 with control valves 20 being provided for controlling operation of the hydraulically powered equipment 10. In many installations, such as a hydraulic trailer 22, the hydraulic hoses 18 are connected to another hose or a tractor mounted hydraulic control valve by a quick coupler 24 which includes a male component and a female component which are quickly and easily connected by merely inserting the male component into the female component with interconnecting latching or detent structure securing the two components in connected, sealed relation.

Each of the two components in the quick coupler have a spring biased valve, usually a steel ball valve, engaged with a valve seat when the quick coupler components are disconnected. When the quick coupler 24 components are connected, the valves contact each other and move each other away from the valve seat thereby communicating the hose with another hose or a source of hydraulic pressure.

When the hydraulic trailer 22 is to be disconnected from the tractor 12, the hydraulic control valve is closed and the quick coupler components disconnected by manually releasing the latch or detent structure with the valves closing when the quick coupler components are separated.

The steel ball in the quick coupler connected to the hose is pushed against its seat by the pressure within the hose which prevents hydraulic fluid or oil in the hose from draining onto the ground surface or the like.

Frequently, the hydraulic fluid on the trailer 22 will become heated and due to expansion of the hydraulic fluid in response to temperature changes will apply force to the hydraulic hose and maintain relatively high pressure in the hose. Then, when it is desired to recouple the quick coupler component on the hose to a quick coupler component connected to the tractor mounted hydraulic control valve, or to connect it to another hose, it is quite difficult to move the steel ball valve in the quick coupler component on the hose away from the valve seat.

The pressure in the hydraulics of the hydraulic trailer can reach as much as 600 psi. The high pressure has resulted in hydraulic fluid leaks to the environment.

What is needed is a hydraulic pressure reducer to prevent the hydraulic fluid from becoming pressurized when the trailer is disconnected.

### SUMMARY

In accordance with the present disclosure, there is provided a hydraulic pressure reducer comprising a body having a first section and a second section coupled to the first section. A diaphragm is coupled between the first section and the second section. The first section and the second section define a fluid reservoir and an expansion region on opposite sides of the diaphragm. A biasing element is located in the expansion region, the biasing element is coupled to the diaphragm and is configured to bias the diaphragm responsive to a hydraulic fluid pressure acting on the diaphragm.

In an exemplary embodiment the fluid reservoir is configured to change volume responsive to a change of hydraulic fluid volume.

In an exemplary embodiment the diaphragm is configured to flex responsive to a change of hydraulic fluid volume, the hydraulic fluid volume comprising one of an expansion and a contraction.

In an exemplary embodiment the biasing element is configured to exert a force on the diaphragm and contract a volume of the fluid reservoir.

In an exemplary embodiment the biasing element is configured to change position responsive to a change of hydraulic fluid volume, the hydraulic fluid volume comprising one of an expansion and a contraction.

In an exemplary embodiment the biasing element comprises a disc coupled to a first end of a rod, the rod extends through the second section of the body.

In an exemplary embodiment the rod comprises a second end opposite the first end, the second end of the rod extends outside of the second section, an adjustable member coupled to the second end, the adjustable member is configured to change a length of travel of the rod relative to the second section of the body.

In an exemplary embodiment the hydraulic pressure reducer further comprises a spring coupled to the disc, the spring is configured to apply a force to the disc opposite the hydraulic fluid pressure.

In an exemplary embodiment the biasing element comprises a cushion of air in the expansion region.

In an exemplary embodiment the diaphragm comprises a piston disposed in a cylinder.

In an exemplary embodiment the piston disposed in the cylinder is coupled to the biasing element within the expansion region.

In an exemplary embodiment the piston disposed in the cylinder is coupled to the biasing element, the biasing element comprising a pair of springs coupled to an exterior of the body.

In another exemplary embodiment a hydraulic system comprises a hydraulic fluid circuit including a hydraulic pressure reducer. The hydraulic fluid circuit comprises a supply line and a return line. A quick connect coupler is fluidly coupled to each of the supply line and the return line. A hydraulic control valve set is coupled to the supply line and the return line downstream of the quick connect couplers. A hydraulic piston cylinder assembly is coupled to the supply line and the return line downstream of said hydraulic control valve set. The hydraulic pressure reducer is fluidly coupled to at least one of the supply line and the return line between the quick connect coupler and the hydraulic control valve set.

In an exemplary embodiment the hydraulic system further comprises a hydraulic trailer supporting the hydraulic fluid circuit.

In an exemplary embodiment the hydraulic system is detachably coupled to a hydraulic power source, the hydraulic power source coupled to at least one of a tractor trailer truck, an agricultural equipment device, a fork lift, an industrial equipment device.

In an exemplary embodiment the hydraulic pressure reducer comprises a body having a first section and a second section coupled to the first section; a diaphragm is coupled between the first section and the second section; the first section and the second section defining a fluid reservoir and an expansion region on opposite sides of the diaphragm; and a biasing element located in the expansion region, the biasing element coupled to the diaphragm and is configured to bias the diaphragm responsive to a hydraulic fluid pressure acting on the diaphragm.

In accordance with the present disclosure, there is provided a method of reducing excessive pressure in static hydraulic systems comprises coupling a hydraulic pressure reducer to the hydraulic system, wherein the hydraulic system comprises a hydraulic fluid circuit, the hydraulic fluid circuit comprises a supply line and a return line; a quick connect coupler is fluidly coupled to each of the supply line and the return line; a hydraulic control valve set is coupled to the supply line and the return line downstream of the quick connect couplers, a hydraulic piston cylinder assembly is coupled to the supply line and the return line downstream of the hydraulic control valve set; and the hydraulic pressure reducer is fluidly coupled to at least one of the supply line and the return line between the quick connect coupler and the hydraulic control valve set; wherein the hydraulic pressure reducer comprises a body having a first section and a second section coupled to the first section; a diaphragm is coupled between the first section and the second section; the first section and the second section defining a fluid reservoir and an expansion region on opposite sides of the diaphragm; and a biasing element is located in the expansion region, the biasing element is coupled to the diaphragm and configured to bias the diaphragm responsive to a hydraulic fluid pressure acting on the diaphragm; and changing a volume of the fluid reservoir and the expansion region of the hydraulic pressure reducer responsive to a change in a hydraulic fluid volume in the hydraulic system.

In an exemplary embodiment the method further comprises reconnecting a hydraulic power source to the hydraulic system quick connect coupler in the absence of hydraulic fluid pressure.

In an exemplary embodiment the method further comprises reducing hydraulic fluid leakage from the quick connect coupler by reducing hydraulic fluid pressure acting on the quick connect coupler.

In an exemplary embodiment the method further comprises replacing hydraulic fluid into the hydraulic system responsive to reconnection of the hydraulic power source to the quick connect coupler.

In an exemplary embodiment the method further comprises resetting the pressure reducer biasing element responsive to hydraulic fluid pressure changes.

Other details of the hydraulic pressure reducer are set forth in the following detailed description and the accompanying drawings wherein like reference numerals depict like elements.

### BRIEF DESCRIPTION OF THE DRAWINGS

FIG. 1 is an illustration of a tractor trailer with hydraulic trailer;

FIG. 2 is an illustration of an exemplary hydraulic system with hydraulic pressure reducer;

FIG. 3 is an illustration of the exemplary hydraulic pressure reducer;

FIG. 4 is an illustration of the exemplary alternative embodiment of a hydraulic pressure reducer;

FIG. 5 is an illustration of an exemplary alternative embodiment of a hydraulic pressure reducer;

FIG. 6 is an illustration of an exemplary alternative embodiment of a hydraulic pressure reducer.

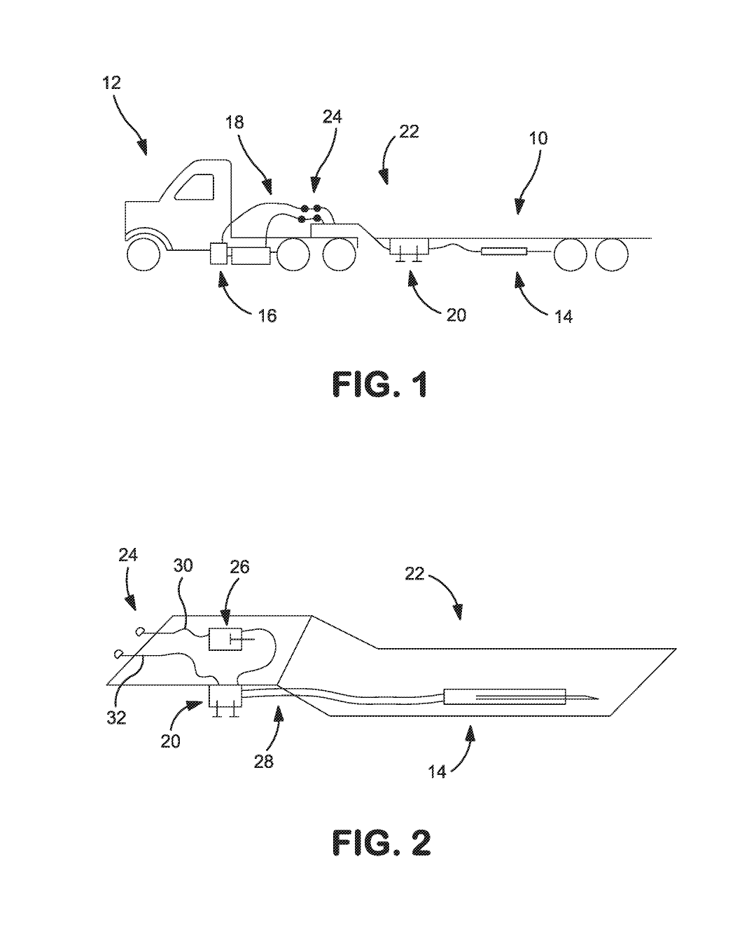

### DETAILED DESCRIPTION

Referring now to FIG. 2, an exemplary hydraulic trailer 22 is shown equipped with a hydraulic pressure reducer, or simply reducer 26. The hydraulic pressure reducer 26 is coupled to a hydraulic system 28. The hydraulic system 28 includes, the hydraulic piston cylinder assembly 14, control valves 20 and quick coupler 24 as described above configured to couple the hydraulic system 28 of the hydraulic trailer 22 to the source of hydraulic pressure 16 on the tractor truck 12. The hydraulic system 28 includes the control valves 20 one for each of the return line 30 and supply line 32 of the hydraulic system 28 The reducer 26 can be installed between the quick coupler 24 and the control valves 20 on either one of the hydraulic lines, 30, 32. In a preferred embodiment, the reducer 26 is fluidly coupled to the return hydraulic line 30, such that the hydraulic fluid can circulate normally in the hydraulic system 28.

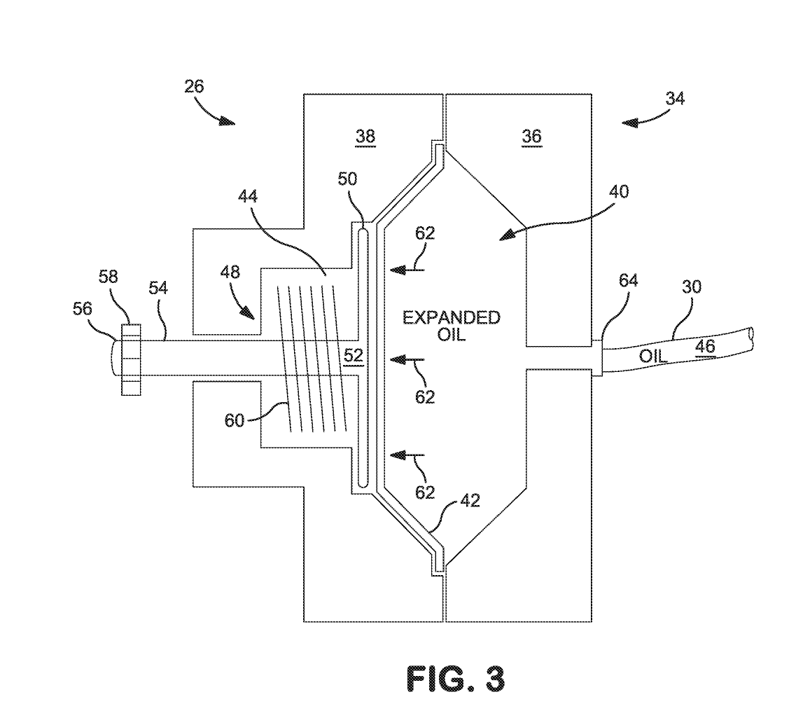

Referring to FIG. 3, an exemplary hydraulic pressure reducer 26 is shown. The reducer 26 includes a body 34 including a first section 36 and second section 38 coupled to the first section 36. The first section 36 and second section 38 can be bolted together in an exemplary embodiment. The first section 36 and second section 38 when coupled form a fluid reservoir 40. The fluid reservoir 40 includes a diaphragm 42 that separates the reservoir 40 from an expansion region 44. The expansion region 44 is shown proximate the second section 38. The fluid reservoir 40 is configured to receive hydraulic fluid 46 from in the hydraulic line 30. As the hydraulic fluid 46 expands in the hydraulic system 28, the fluid reservoir 40 volume changes to accommodate the expansion. In the embodiment shown at FIG. 3, the diaphragm 42 flexes to change the fluid reservoir 40 volume. The reducer 26 includes a biasing element 48. The biasing element 48 is configured to bias the diaphragm 42 allowing the diaphragm 42 to flex responsive to the pressure of the hydraulic fluid 46. As the hydraulic fluid 46 increases pressure, the diaphragm 42 flexes and expands the volume of the fluid reservoir 40. As the hydraulic fluid 46 decreases in pressure, the diaphragm 42 flexes and contracts the volume of the fluid reservoir 40. The biasing element 48 exerts a force on the diaphragm 42 to contract the volume of the fluid reservoir 40. As the fluid reservoir 40 expands with the diaphragm 42 in response to the increased hydraulic pressure, the biasing element 48 yields and changes position.

In the embodiment shown in FIG. 3, the biasing element 48 includes a disc 50 coupled to a first end 52 of a rod 54 that extends through the second section 38 of the body 34. A second end 56 of the rod 54 extends outside of the second section 38 and includes an adjustable member 58 configured to translate along the rod 54 to change the length of travel the rod 54 translates relative to the second section 38. A spring 60 is coupled to the disc 50 and is configured to apply the force on the disc 50. The disc 50 applies force on the diaphragm 42 opposite the hydraulic fluid pressure forces, shown as arrows 62 applied on the diaphragm in the opposite direction of the spring force.

In operation the reducer 26 receives the hydraulic fluid 46 at a fluid coupling 64, coupled to hydraulic line or simply, hose 30 of the hydraulic system 28 and fills the fluid reservoir 40, expanding the volume. The fluid pressure 62 expands the diaphragm 42. The biasing element 48 translates and retracts in response to the hydraulic fluid pressure 62. The spring 60 changes position and increases in potential energy responsive to an increase in hydraulic fluid pressure. As the hydraulic fluid 46 pressure reduces the biasing element 48 presses the diaphragm 42 and contracts the reservoir 40 volume. The spring releases the potential energy and forces the diaphragm 42 against the decreasing hydraulic fluid pressure 62. In practice, as the hydraulic fluid 46 increases pressure, for example due to thermal expansion, the reducer 26 expands hydraulic system volume to accommodate the increased pressure, thus minimizing the magnitude of the pressure in the hydraulic fluid 46.

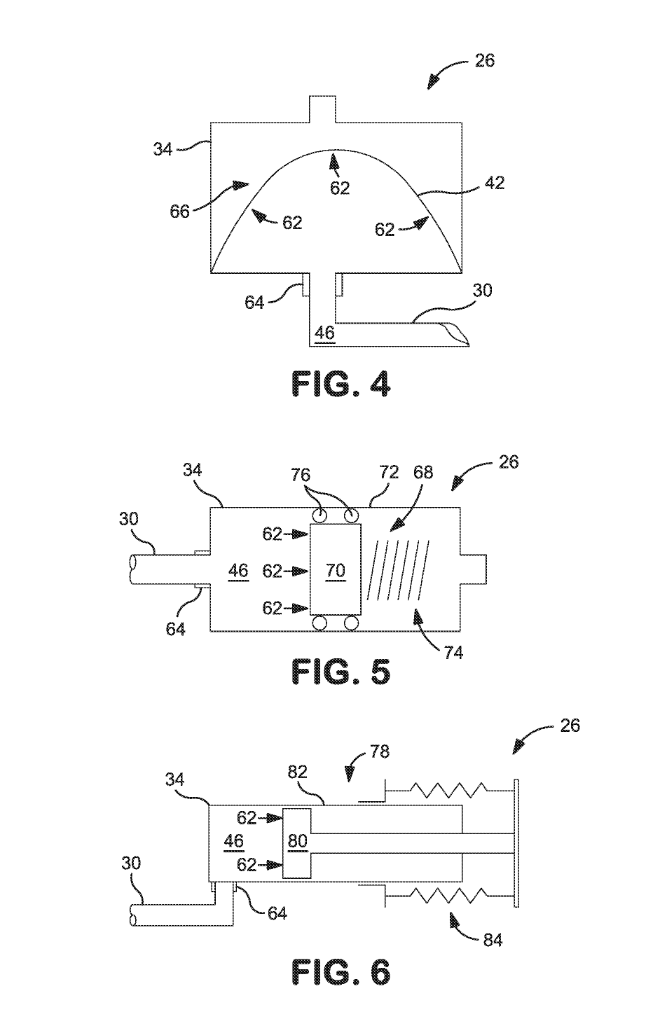

In exemplary embodiment, shown at FIG. 4, the hydraulic pressure reducer 26 includes a body 34 with a coupling 64 coupled to a hydraulic line 30. The biasing element 66 includes the flexible diaphragm 42 similar to the one shown at FIG. 3, except there is no spring, rod and disc assembly included. The biasing element 66 and a cushion of air at a given pressure along with the flexible diaphragm 42 and the material properties of the diaphragm 42 are relied on to apply resistive pressure to the hydraulic fluid 46. The diaphragm 42 reacts to the change in hydraulic fluid pressure similarly to the reducer configuration described above.

In exemplary embodiment, shown at FIG. 5, the hydraulic pressure reducer 26 includes a body 34 with a coupling 64 coupled to a hydraulic line 30. The diaphragm is configured as a piston 70 in cylinder 72 configuration that is coupled to a spring 74 and is relied on to apply resistive pressure to the hydraulic fluid 46. A set of seals 76, typically an O-ring, is utilized to seal the piston and cylinder interface, preventing the hydraulic fluid 46 from leaking past the piston 70 along the cylinder 72 and piston 70 interface. The spring 74 provides the force that acts on the piston 70 and responds to the changes in hydraulic pressure 62.

In another exemplary embodiment, shown at FIG. 6, the hydraulic pressure reducer 26 includes a body 34 with a coupling 64 coupled to a hydraulic line 30. The biasing element 78 includes a piston 80 in cylinder 82 configuration that is coupled to a spring 84 and is relied on to apply resistive pressure to the hydraulic fluid 46. In this embodiment, the spring 84 includes two springs coupled to an exterior 86 of the body 34. The springs 84 bias the piston 80 against the hydraulic forces 62. A similar seal can be employed in this embodiment between the piston 80 and cylinder 82.

The hydraulic pressure reducer solves a longstanding problem of excessive hydraulic pressure in static hydraulic systems that have no hydraulic fluid reservoirs associated with the trailer or attachment. Every drop of hydraulic fluid that enters the hydraulic fluid system equals a drop of hydraulic fluid that exits the hydraulic system of the trailers or attachments. The reducer reduces pressure in static hydraulic system circuits, typically caused by thermal expansion of the hydraulic fluid due to temperature increases in the hydraulic fluid. The reducer is ideal for use with hydraulic trailers and other hydraulic equipment that are detachable from the hydraulic power source of the hydraulic system. The reducer enables easy reconnection of the hydraulic system at the quick connection couplers. The reducer functions well at low hydraulic pressures. The reducer prevents unwanted environmental degradation as it reduces the hydraulic fluid leaks that are associated with the over pressurization of the hydraulic fluid systems. The reducer automatically replaces the hydraulic fluid into the hydraulic system when the hydraulic system is re-connected at the quick connectors. The reducer also automatically resets to accommodate subsequent hydraulic system pressure changes. The reducer is configured to be employed in the hydraulic system and operate under full hydraulic pressure loads. The biasing element can be configured as a spring or as air pressure.

There has been provided a hydraulic pressure reducer configured to prevent hydraulic over pressure in hydraulic trailers. While the reducer has been described in the context of specific embodiments thereof, other unforeseen alternatives, modifications, and variations may become apparent to those skilled in the art having read the foregoing description. Accordingly, it is intended to embrace those alternatives, modifications, and variations which fall within the broad scope of the appended claims.

1. A hydraulic pressure reducer comprising:
a body having a first section and a second section coupled to said first section;
a diaphragm coupled between said first section and said second section;
said first section and said second section defining a fluid reservoir and an expansion region on opposite sides of said diaphragm; and
a biasing element located in said expansion region, said biasing element coupled to said diaphragm and configured to bias said diaphragm responsive to a hydraulic fluid pressure acting on said diaphragm.

2. The hydraulic pressure reducer of claim 1, wherein said fluid reservoir is configured to change volume responsive to a change of hydraulic fluid volume.

3. The hydraulic pressure reducer of claim 1, wherein said diaphragm is configured to flex responsive to a change of hydraulic fluid volume, said hydraulic fluid volume comprising one of an expansion and a contraction.

4. The hydraulic pressure reducer of claim 1, wherein said biasing element is configured to exert a force on said diaphragm and contract a volume of said fluid reservoir.

5. The hydraulic pressure reducer of claim 1, wherein said biasing element is configured to change position responsive to a change of hydraulic fluid volume, said hydraulic fluid volume comprising one of an expansion and a contraction.

6. The hydraulic pressure reducer of claim 1, wherein said biasing element comprises a disc coupled to a first end of a rod, said rod extends through said second section of said body.

7. The hydraulic pressure reducer of claim 6, wherein said rod comprises a second end opposite said first end, said second end of said rod extends outside of said second section, an adjustable member coupled to said second end, said adjustable member configured to change a length of travel of said rod relative to said second section of said body.

8. The hydraulic pressure reducer of claim 1, further comprising:
a spring coupled to said disc, said spring configured to apply a force to said disc opposite said hydraulic fluid pressure.

9. The hydraulic pressure reducer of claim 1, wherein said biasing element comprises a cushion of air in said expansion region.

10. The hydraulic pressure reducer of claim 1, wherein said diaphragm comprises a piston disposed in a cylinder.

11. The hydraulic pressure reducer of claim 10, wherein said piston disposed in said cylinder is coupled to said biasing element within said expansion region.

12. The hydraulic pressure reducer of claim 10, wherein said piston disposed in said cylinder is coupled to said biasing element, said biasing element comprising a pair of springs coupled to an exterior of said body.

13. A hydraulic system having a hydraulic pressure reducer comprising:
a hydraulic fluid circuit, said hydraulic fluid circuit comprising a supply line and a return line;
a quick connect coupler fluidly coupled to each of said supply line and said return line;
a hydraulic control valve set coupled to said supply line and said return line downstream of said quick connect couplers,
a hydraulic piston cylinder assembly coupled to said supply line and said return line downstream of said hydraulic control valve set; and
said hydraulic pressure reducer fluidly coupled to at least one of said supply line and said return line between said quick connect coupler and said hydraulic control valve set.

14. The hydraulic system of claim 13, further comprising:
a hydraulic trailer supporting said hydraulic fluid circuit.

15. The hydraulic system of claim 13, wherein said hydraulic system is detachably coupled to a hydraulic power source, said hydraulic power source coupled to at least one of a tractor trailer truck, an agricultural equipment device, a fork lift, an industrial equipment device.

16. The hydraulic system of claim 13, wherein said hydraulic pressure reducer comprises:
a body having a first section and a second section coupled to said first section;
a diaphragm coupled between said first section and said second section;
said first section and said second section defining a fluid reservoir and an expansion region on opposite sides of said diaphragm; and
a biasing element located in said expansion region, said biasing element coupled to said diaphragm and configured to bias said diaphragm responsive to a hydraulic fluid pressure acting on said diaphragm.

17. A method of reducing excessive pressure in static hydraulic systems comprising:
coupling a hydraulic pressure reducer to said hydraulic system, wherein said hydraulic system comprises:
a hydraulic fluid circuit, said hydraulic fluid circuit comprising a supply line and a return line;
a quick connect coupler fluidly coupled to each of said supply line and said return line;
a hydraulic control valve set coupled to said supply line and said return line downstream of said quick connect couplers,
a hydraulic piston cylinder assembly coupled to said supply line and said return line downstream of said hydraulic control valve set; and
said hydraulic pressure reducer fluidly coupled to at least one of said supply line and said return line between said quick connect coupler and said hydraulic control valve set;
wherein said hydraulic pressure reducer comprises:
a body having a first section and a second section coupled to said first section;
a diaphragm coupled between said first section and said second section;
said first section and said second section defining a fluid reservoir and an expansion region on opposite sides of said diaphragm; and
a biasing element located in said expansion region, said biasing element coupled to said diaphragm and configured to bias said diaphragm responsive to a hydraulic fluid pressure acting on said diaphragm; and
changing a volume of said fluid reservoir and said expansion region of said hydraulic pressure reducer responsive to a change in a hydraulic fluid volume in said hydraulic system.

18. The method of claim 17 further comprising:
reconnecting a hydraulic power source to said hydraulic system quick connect coupler in the absence of hydraulic fluid pressure.

19. The method of claim 17 further comprising:
reducing hydraulic fluid leakage from said quick connect coupler by reducing hydraulic fluid pressure acting on said quick connect coupler.

20. The method of claim 17 further comprising:
replacing hydraulic fluid into said hydraulic system responsive to reconnection of said hydraulic power source to said quick connect coupler; and
resetting said pressure reducer biasing element responsive to hydraulic fluid pressure changes.

20. (canceled)
